(19) United States
(12) Patent Application Publication
(10) Pub. No.: US 2013/0258106 A1
(43) Pub. Date: Oct. 3, 2013

(54) METHOD OF USING AN IMAGE SENSOR

(71) Applicants: Michel Tulet, Balma (FR); Xavier Sembely, Toulouse (FR)

(72) Inventors: Michel Tulet, Balma (FR); Xavier Sembely, Toulouse (FR)

(73) Assignee: ASTRIUM SAS, Paris (FR)

(21) Appl. No.: 13/992,168

(22) PCT Filed: Nov. 29, 2011
(86) PCT No.: PCT/FR11/52813

§ 371 Date: Jun. 6, 2013

(30) Foreign Application Priority Data
Dec. 6, 2010 (FR) 10 04737

(51) Int. Cl. H04N 9/09

(52) U.S. Cl. CPC H04N 9/09
USPC 348/145

(57) ABSTRACT

A method of using an image sensor onboard a satellite or an aircraft comprises two simultaneous sequences of image capture. The first sequence corresponds to a capture of observation images, and the second sequence corresponds to a capture of images dedicated to the detection of a shifting of the observation images. The images dedicated to the detection of the shifting are restricted to windows that are at least in part contained in a main window the of observation images. Furthermore, said images dedicated to the detection of shifting are captured at a frequency greater than a frequency of the observation images.

### PRIORITY CLAIM

The present application is a National Phase entry of PCT Application No. PCT/FR2011/052813, filed Nov. 29, 2011, which claims priority from FR Application No. 10 04737, filed Dec. 6, 2010, said applications being hereby incorporated by reference herein in their entirety.

### FIELD OF THE INVENTION

The present invention relates to a method of using an image sensor onboard a satellite or an aircraft, as well as to an image sensor and an image capture device adapted to implement such a method.

### BACKGROUND OF THE INVENTION

An increasing number of Earth observation or reconnaissance missions require obtaining images with a very high resolution. These may include observation missions that are carried out from a satellite; this latter possibly being a low-orbit satellite, a geostationary satellite or a satellite on an intermediary circular or elliptical orbit. For example, a resolution lower than 1 meter can be asked for images that have been captured from a low-altitude satellite, and a resolution lower than 50 meters for images captured from a geostationary satellite. But then, under such imaging conditions, the resolution obtained is limited by the variations in the line of sight of the imaging system used that occurred during the period of exposure that was implemented to capture each observation image. Such unintentional line-of-sight variations may have multiple causes including vibrations generated by moving parts onboard the satellite, in particular the attitude control systems of the satellite. These variations generate, in turn, high-frequency distortions of the imaging system and these distortions further contribute to the line-of-sight variations. Professionals refer to these unintentional line-of-sight variations during exposure of each image capture as “image jitter.”

Various methods have been proposed to characterize or measure image jitter. Most of them are based on the high-frequency capture of data that characterize the line-of-sight variations during each exposure. To that end, a metrology device is added to the imaging system to act as an inertial or pseudo-inertial reference. But then, the devices based on gyroscopes or accelerometers are unable to sense vibrations whose frequencies are as high as those that occur onboard a satellite, and they are unable to sense the contributions of the distortions of the imaging system itself to the line-of-sight variations.

Laser-based metrology devices have also been proposed to be used as a pseudo-inertial reference. Images of a reference laser beam are therefore captured and processed at high speed in order to characterize the vibrations and distortions of the imaging system during each observation image capture exposure. But the addition of such a laser device to the imaging system that acts as a pseudo-inertial reference makes the design and realization of this system more complex. Its cost price is therefore increased, as is its weight, which is a great handicap especially when the imaging system is intended to be loaded onboard a satellite, particularly with respect to the cost of launching the satellite.

It has equally been proposed to capture and process at high speed, during the exposure for each observation image, the images of the stars that are used as fixed landmarks on account of their distance. A secondary image sensor is therefore dedicated to the capture of these images independently from the main image sensor, which is dedicated to the capture of the observation images. However, the general structure of the imaging system becomes even more complex when it combines these two systems, and the cost price of the whole system is further increased.

It has notably been proposed to use image sensors dedicated to the detection of image jitter that are separate from the system dedicated to observation. Such image jitter sensors are designed to sense any line-of-sight variations at a high frequency. However, these are still additional sensors that increase the total cost of the whole imaging system. Moreover, their performances can hardly be guaranteed because they depend on the texture of each area that is imaged on these image jitter sensors.

One of the objects of the present invention is therefore to provide a method to characterize image jitter that occurs during the capture of an observation image, whereby previous drawbacks are limited or completely absent.

### SUMMARY OF THE INVENTION

Specifically, a first object of the invention is to characterize the image jitter including its components at high frequencies.

A second object of the invention is to characterize the image jitter with the contributions to it that result from distortions of the observation imaging system.

A third object of the invention is to characterize the image jitter without significantly increasing the total weight and cost price of the systems onboard the satellite or the aircraft, nor making the imaging system more complex.

A fourth object of the invention is to keep the entire photo-sensitive surface of the image sensor available for the function of capturing observation images.

Finally, a fifth object of the invention is to provide a characterization of the image jitter in the highest possible number of circumstances, especially even when some areas of the image that is formed on the photo-sensitive surface of the sensor exhibit a very low contrast.

In order to achieve these objects and others, the invention proposes a new method of using an image sensor onboard a satellite or an aircraft. The image sensor comprises a matrix of photodetectors that are arranged along lines and columns of this matrix and it further comprises a plurality of line decoders and a plurality of column decoders, an addressing circuit and a sequencer that is coupled to the matrix of photodetectors through the addressing circuit. In this way, an individual operation of each photodetector can be controlled according to accumulation, reading and reset steps.

According to a first characteristic of the invention, the method comprises a first image capturing sequence, which is performed using the photodetectors of a first selection within the matrix, and which is repeated at a first frequency to capture a first series of images at this first frequency. This first image capture sequence comprises an accumulation step, a reading step and a reset step for each photodetector of the first selection. This first selection of photodetectors may correspond to all photodetectors of the matrix.

According to a second characteristic of the invention, the method further comprises a second image capture sequence, which is performed using a second selection of photodetectors also within the matrix, and which is repeated at a second frequency to capture a second series of images at this second frequency. The second frequency is higher than the first frequency and the first selection comprises more photodetectors than the second selection, with a plurality of photodetectors that are common to both selections.

According to a third characteristic of the invention, the second image capture sequence does not comprise a reset step for each photodetector that is common to both selections. In this way, an accumulation step for photodetectors that are common to the first and second selections, which runs just before a reading step performed for the common photodetectors according to the second image capture sequence, continues just after this reading step that is carried out according to the second image capture sequence.

Finally, according to a fourth characteristic of the invention, a plurality of images of the second series are captured with the photodetectors of the second selection while only one image of the first series is captured with the photodetectors of the first selection.

In this way, the invention proposes capturing images according to two overlapping sequences and using selections of photodetectors that are different. The first sequence, with the lower image capture frequency, is intended to provide observation images, while the second, with the greater frequency, is dedicated to the characterization of the line-of-sight variations, that is, of the image jitter of the observation images.

A same image formation optic can be easily used for the images of the first series and those of the second series, in particular because the same matrix of photodetectors is used for these two series. For this reason, the weight onboard a satellite or an aircraft from which observation images are captured is not increased. Also, the design of the image formation optic is not specially modified to allow characterizing the image jitter, so that the satellite launching cost and the cost price of the imaging system are not significantly increased.

Moreover, and because the images that are dedicated to the image jitter characterization and the observation images can be produced by the same optic and are captured by the same matrix of photodetectors, the image jitter that is detected comprises all the contributions available, not just those whose causes are external to the imaging system, but also the contributions of the imaging system's own distortions.

Furthermore, the second frequency of image capture is only limited by the maximum frequency with which the photodetectors in the second selection can be read without being reset. This second frequency can therefore be high, especially if the number of photodetectors in the second selection is not too high. For this reason, the method according to the invention allows sensing variations that correspond to high frequencies, using images from the second series.

Particularly, the method according to the invention can be used to sense variations in the line-of-sight of the imaging system that comprises the image sensor. These variations are detected using a comparison of pattern positions within the images that are successively captured according to the second image capture sequence using the photodetectors from the second selection. High-frequency components of these line-of-sight variations can thus be detected. Variations in the line-of-sight can then be compensated for within the image-capturing instrument, especially by prompting appropriate movements of certain optical components, preferably in an analog manner.

According to a first possible use of a method according to the invention, the line-of-sight variations that are detected may be used to control a system for compensating for these line-of-sight variations. These line-of-sight variations may, preferably, be compensated for by moving at least one optical component of the imaging system that comprises the image sensor.

According to a second possible use of the invention onboard a satellite or an aircraft, the line-of-sight variations that are detected may be used to control an attitude control system of the satellite or aircraft.

The invention also proposes the image sensor that is suitable to be arranged onboard a satellite or an aircraft. This image sensor comprises the matrix of photodetectors, the decoders of the lines and columns of this matrix, the addressing circuit and the sequencer, the latter being suitable to control the first and second image capture sequences according to the previously described method.

The sequencer may further be adapted to ensure that the second selection of photodetectors be comprised in the first selection, and/or that the photodetectors of the second selection be adjacent within at least one window in the matrix.

Finally, the invention proposes an image capture device that comprises such image sensor and a module to detect line-of-sight variations. In this device, the module that detects the line-of-sight variations is adapted to compare pattern positions within the images that are successively captured according to the second image capture sequence using the photodetectors of the second selection, and to detect these variations using a result of the comparison.

### BRIEF DESCRIPTION OF THE DRAWINGS

Other specificities and advantages of the present invention shall be revealed in the following descriptions of several non-limiting implementation examples, with reference to the appended drawings, in which:

FIG. 1 shows a perspective view of application of the invention with an observation satellite;

Figure is a schematic representation of a structure of an image capture device, adapted to implement the invention;

Figure shows an example of a distribution of windows adapted for the invention inside a matrix of photodetectors;

FIGS. 4a and 5a are two time-diagrams that show respectively two variants of a sequential image capture mode known from prior art; and

FIGS. 4b and 5b correspond respectively to FIGS. 4a and 5a, for two possible implementations of the invention.

### DETAILED DESCRIPTION OF THE DRAWINGS

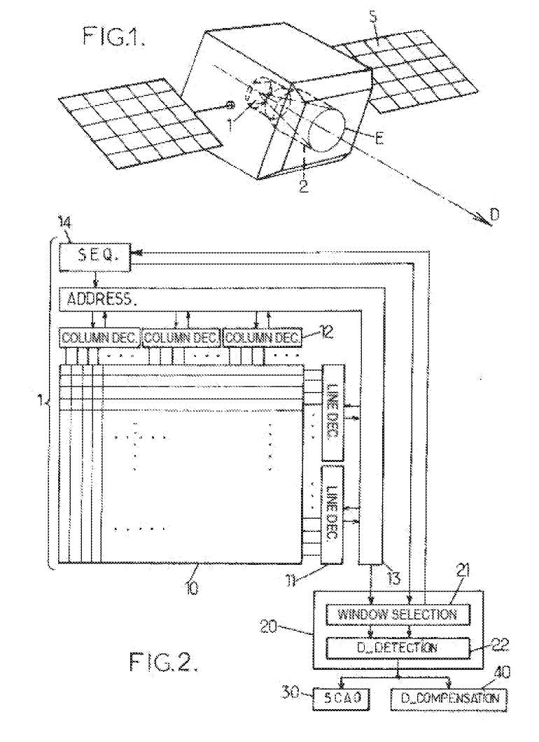

As FIG. 1 shows, an imaging system is placed onboard a satellite S, which may be at a low altitude or geostationary in orbit around Earth or another planet. The imaging system comprises, as is common practice, an image formation optic 2 and an image sensor 1, which is situated in an image formation plane of the optic 2. E refers to the optical input of the optic 2, and D refers to the line-of-sight of the imaging system. The line-of-sight D can vary during an exposure period of the photodetectors of the sensor 1 because of vibrations of the satellite S as a whole, of vibrations generated by moving parts onboard the satellite S and that are transmitted to the imaging system, of distortions of the imaging system, etc. Such imaging system distortions can involve for example the image formation optic 2, or modify the position of the sensor 1 relative to this optic 2. Specifically, high-frequency vibrations that are suffered by the imaging system are likely to themselves cause distortions of this system. Line of sight D variations appear as a result, often occurring during the exposure period of the photodetectors when capturing an observation image. The invention as described allows detecting and characterizing these line-of-sight D variations.

The invention consists in a new use of the matrix of photodetectors of the image sensor 1, which allows detecting the line-of-sight D variations without it being necessary to add one or more additional sensors acting as an inertial or pseudo-inertial reference.

The invention is described within the context of the image capture mode using a matrix sensor called “starer,” when the image is fixed on the sensor during the image capture period.

The matrix of photodetectors of the image sensor 1 comprises a plurality of adjacent lines and columns of the photodetectors, for example several thousands of photodetectors along the two respective directions of lines and columns. A main window is fixed within this matrix to capture the observation images. This main window may correspond to the entire matrix of photodetectors, but not necessarily. It constitutes the first selection of photodetectors inside the image sensor matrix, which has been introduced earlier in the general description section.

According to the invention, at least one, and preferably a plurality of, secondary windows are also defined within the photodetector matrix. Each secondary window has a number of photodetectors that is less than or much less than that of the main window. The secondary windows form all together the second selection of photodetectors within the matrix of the sensor 1.

It is not necessary that all the secondary windows be within the main window, but each of them shares common photodetectors with the main window. It can be considered that the secondary windows are limited to the shared photodetectors, so that the secondary windows may appear to be contained within the main window. In this way particularly, the second selection of photodetectors may be comprised in the first selection.

Preferably, each main or secondary window contains all the neighboring photodetectors in the matrix of the image sensor 1 that are inside a peripheral limit of this window. Specifically, the photodetectors of the second selection may thus be adjacent within the secondary window(s). Typically, each secondary window may contain a hundred times fewer photodetectors than the main window

The operation of each photodetector varies therefore depending on whether this photodetector belongs to a secondary window or is situated in the main window outside the secondary windows.

The photodetectors of the main window outside the secondary windows are used in the usual manner, following consecutive accumulation, also called integration, reading and reset steps. This sequence of steps has been called first sequence in the general section of this description. The observation images are therefore captured outside the secondary windows, at a first frequency when said first sequence is repeated.

The photodetectors of the secondary windows are used according to a double implementation pattern.

On the one hand, they are used in accordance with the first image capture sequence, in a way that is identical to the main window photodetectors that are situated outside the secondary windows. The first image capture sequence, which produces observation images, is therefore performed and repeated at the first frequency for all the photodetectors of the main window. In this way, the observation images are complete within the entire main window. They are called first series of images, and they can be captured using one of the known modes of control of an image sensor matrix, especially the “snapshot mode,” the “rolling mode” or the “progressive scan mode”.

On the other hand, the photodetectors of the secondary windows are used in accordance with a second image capture sequence, which is repeated at a second frequency, higher than the first frequency.

The second image capturing sequence for each photodetector of the secondary windows is performed at the same time as the first sequence, during the periods of accumulation of this first sequence. It comprises a reading step of the photodetector in order to capture the level of accumulation that is reached at the time of this reading. However, so that the image capture according to the first sequence is not disturbed by that of the second sequence, it is necessary that the second sequence not comprise a reset step for the photodetectors. Specifically, thanks to this absence of the reset step, the signal/noise ratio of the data of the observation image that are read according to the first sequence of image capture is not degraded in the secondary windows, with respect to its value outside these same secondary windows. Thus, a plurality of reading steps are performed successively for each photodetector of the secondary windows, according to the second image capture sequence during one accumulation step performed according to the first capture sequence. Then this accumulation step is followed by the reading step with reset of the first image capture sequence. In this way, in addition to their utilization to capture the complete observation image, the photodetectors of each secondary window, that is the photodetectors of the second selection, simultaneously provide secondary images to the second frequency, which are called the second series of images.

FIG. 2 shows the structure of an image capture device that allows implementing the just-described two-simultaneous-sequences method. The image sensor 1 usually comprises the photodetectors matrix 10, a plurality of line decoders 11 marked LINE DEC., a plurality of column decoders 12 marked COLUMN DEC., an addressing circuit 13 marked ADDRESS. and a sequencer 14 marked SEQ. This device allows individual addressing of the photodetectors of the matrix 10. To that end, the matrix of photodetectors 10 may be of CMOS technology. The sequencer 14 is coupled to the matrix 10 by the addressing circuit 13, and allows controlling the individual operation of each photodetector to carry out a scheduled series of accumulation, reading and reset steps. Thus, the sequencer 14 is programmed to control the first image capture sequence described above for all the photodetectors of the main window, and the second image capture sequence in addition to the first sequence for the photodetectors of the secondary windows.

It is therefore possible to detect variations in the line-of-sight D during each accumulation performed to capture an observation image, by comparing the positions of at least one pattern inside the images that are successively captured according to the second sequence, in at least some of the secondary windows. Possibly, an analysis of the image texture may be further performed, especially in order to select the pattern in addition to the use of the pattern itself. Advantageously, the characteristics of the pattern or of the texture may be determined a priori in an Earth-based station before capturing an image, by processing the images that have been captured beforehand, especially by using the same device. Such an application may be interesting to observe one and same zone at different times, or to seek the possible presence of moving elements inside a monitoring area, for example. It is well known that pattern, image texture and contrast are distinct characteristics of an image.

To that end, the image capture device further comprises an image processing unit 20, which itself comprises a module 21 for the selection of windows and a module 22 for the detection of variations in the line-of-sight D, marked D-DETECTION. Several strategies may be implemented in turn by the module 21 to select, within the matrix 10, the secondary windows for which the sequencer 14 shall control the second image capture sequence.

According to a possible first strategy, at least one of the secondary windows that are used to capture images according to the second sequence is selected within the photodetector matrix 10 from an image that was captured beforehand according to the first sequence. In other words, a first image is first captured with all the photodetectors of the main window, and parts of this first image are sought to form the secondary windows that will be used subsequently for the second image capture sequence. The secondary windows are therefore definitively fixed for this image capture or for the image capture sequence that relates to a same observed zone. At least one of these secondary windows may be selected based on the image captured beforehand depending on one of the following criteria, or a combination of these criteria:
/i/ an image texture within the window for the image captured beforehand;
/ii/ an absence of clouds within the window for the image captured beforehand; and
/iii/ when a plurality windows are used for the images captured according to the second sequence, a distribution of these windows within the matrix 10 of the photodetectors.

Criterion /i/ in a general manner and criterion /ii/ in the specific case of an observation of the surface of Earth, ensure that the images that are captured later according to the second sequence in the secondary windows contain at least one pattern whose successive positions within these images can be compared amongst themselves. Criterion /iii/ allows comparing the movements of patterns in different zones of the main window. It is therefore possible to derive therefrom it a characterization of the movement of the imaging system during each observation image accumulation, and specifically the line-of-sight D variations. Specifically, it is possible to distinguish a rotation movement around the line-of-sight D from a transversal movement.

According to a second strategy for the selection of the secondary windows, a plurality of windows smaller than the main window are fixed a priori. Within each of them, images are captured according to the second sequence. For example, a uniform distribution of small secondary windows inside the main window may be adopted. The first and second image capture sequences are therefore implemented as that has been described. The main window is therefore used to capture the first series of images for the purposes of observation, and the smaller windows are used to capture the second series of images respectively with each of these smaller windows. Then, at least one of these smaller windows is selected and the images of the second series that have been captured with this (these) selected window(s) is (are) used to detect the line-of-sight D variations using the successive positions of the patterns in this (these) selected window(s). In other words, the second image capture sequence is performed with a number of secondary windows that is more than is necessary, and then a selection of some of these secondary windows is performed to determine the movement of the imaging system. This a posteriori selection of the secondary window(s) can be performed using the same criteria as those quoted above regarding the first strategy.

FIG. 3 shows a distribution of the secondary windows in the photodetector matrix 10, as such a distribution can result from either of the two just-presented strategies. In this figure, reference M10 designates more specifically the peripheral limit of the photodetector matrix 10. The figure shows an example of a scene on Earth which is imaged on the matrix 10. Reference W1 designates the peripheral limit of the main window, and references W2 designate the respective peripheral limits of a plurality of secondary windows that are used to detect the line-of-sight D variations. The secondary windows are situated within the main window and contain contrasting patterns that can be tracked in the images captured successively according to the second sequence. Specifically, one of the secondary windows represented contains a crisscross pattern which is a town situated in the field of observation. Another secondary window contains a strip-like pattern that is a runway. Furthermore, the secondary windows are far enough away from each other inside the main window.

Of course, other strategies for the selection of windows in the matrix 10 can be used instead of those that have just been described in detail.

In order to implement the invention onboard a satellite S or an aircraft, module 22 may be adapted to transmit data that represent line-of-sight D variations, to an attitude control system 30 of the satellite or aircraft, marked SCAO on FIG. 2. Alternatively or simultaneously, module 22 may also transmit its data to system for compensating for the jitter of the imaging system. Such jitter compensation system is referenced 40 and is marked D-COMPENSATION. It may help reducing in real time the line-of-sight D variations during the accumulation steps by compensating for the movements of the image in the focal plane, that are caused by the vibrations and the distortions suffered by the image capture device.

Such a jitter compensation at the level of the image-capturing instrument may be performed by correcting in real time the line-of-sight in the instrument. This correction may be done by moving:
the focal plane, or the image sensor in this focal plane, for example using a piezoelectric actuator, or
an optical component, for example a reflecting mirror that is placed upstream of the image sensor.

These two examples of compensation are provided as non-limiting examples, and their implementations are known to professionals. Compared to the jitter compensation methods that come through processing of the image, those that operate by compensating for the line-of-sight variations inside the image-capturing instrument can be analog. The latter provide a higher accuracy without requiring calculations, which is particularly advantageous for space applications. Indeed, space applications require the use of specific technologies to meet constraints that do not exist for Earth-based applications. Among these constraints that are specific to space applications, there is the limitation of the number of onboard components, or the requirement for manufacturing and qualification methods that are designed to provide a very high reliability and that are therefore very costly.

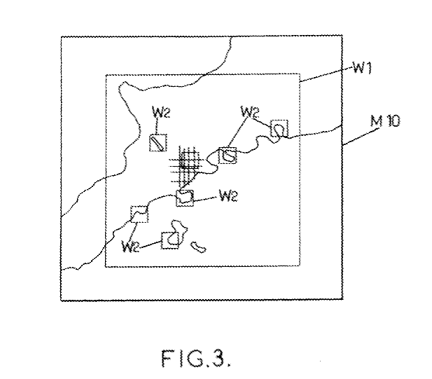

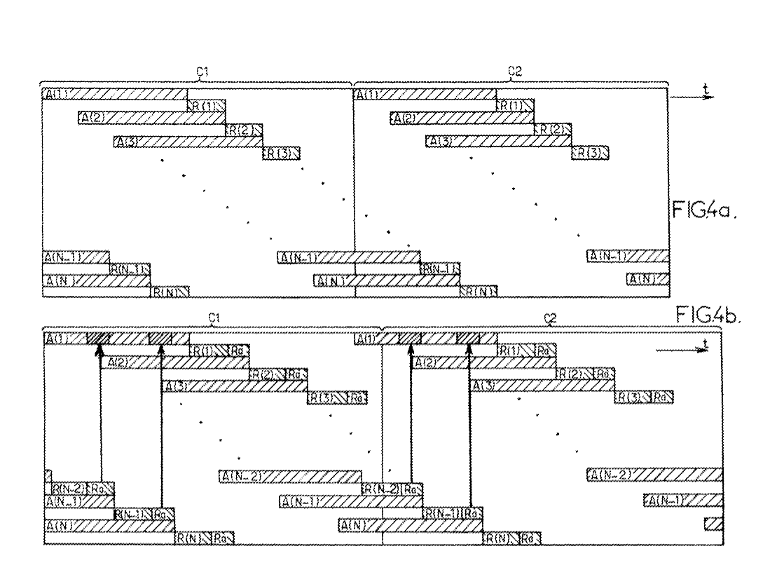

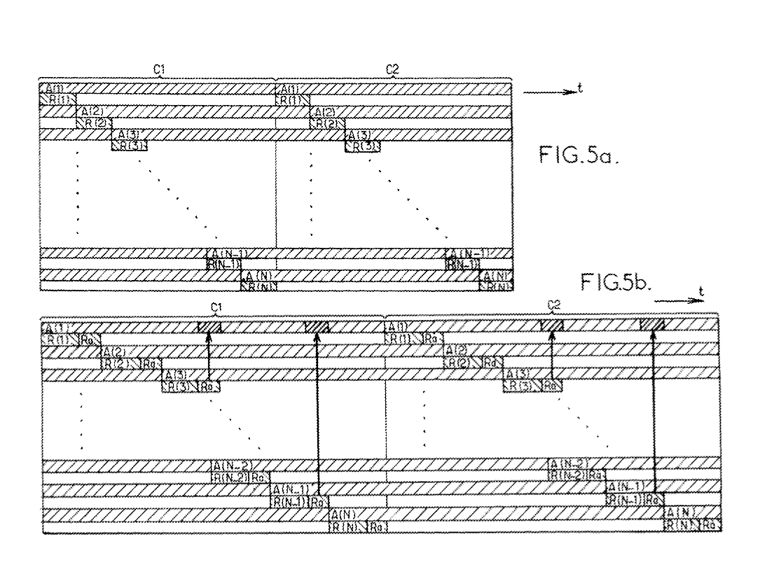

Finally, FIGS. 4 (4a, 4b) and 5 (5a, 5b) show two examples of implementation of the first and second image capture sequences introduced by the invention, such that these sequences can be controlled in a chronological manner by the sequencer 14. The horizontal direction of these diagrams represent time, marked t. Respective time periods of the capture of two successive observation images are represented in frame C1 for the first one, and in frame C2 for the second one. These observation images are captured using the sequential mode (“rolling”) for all the FIGS. 4 and 5, with an accumulation time which is less than the period of capture of the observation images for FIGS. 4a and 4b, and equal to the period of capture for FIGS. 5a and 5b. Each line of the matrix 10 is thus exposed during an accumulation period which is referenced A(i) for line i, the integer i being the number of lines of the matrix 10 between its first line marked 1 and its last line marked N. The accumulation period for each line i and for each period of capture of an observation image is followed by a reading step, referenced R(i) for line i. A reset of the photodetectors of line i is performed simultaneously at the beginning of the observation image reading step for this same line i. According to the sequential mode, the reading steps R(i) of the different lines of the photodetectors are gradually offset during each period of capture of observation images.

FIGS. 4a and 5a are time-diagrams of the sequential capture mode as it exists in prior art in its two variants, with an accumulation period inferior to or equal to the period of capture of observation images respectively.

In accordance with the diagram of FIG. 4b, each reading step of line R(i) can be followed by an additional step Ra of reading of the secondary window. Preferably, these additional reading steps Ra are dedicated in an equivalent manner to the reading of all the secondary windows that are used, so that all the secondary windows are read using the same value of the second frequency. The performing of the additional steps Ra for reading the secondary windows is provided during the programming of the sequencer 14. For the sake of clarity of FIG. 4b, only the additional steps Ra that are dedicated at least in part to the reading of portions of line 1 of the photodetector matrix 10, that belong to the secondary windows, are indicated. These assignments of steps Ra are represented by vertical arrows in the diagram. These portions of line 1 that belong to secondary windows and that are read during the additional steps Ra have closed hatchings. From this illustration for the line 1 of photodetectors, the professional will be able to continue the assignment of the additional reading steps Ra to the portions of other lines of the matrix 10 that also belong to the secondary windows. According to the invention, all the portions of lines of photodetectors that are read during these additional steps Ra are not reset at the beginning, during or at the end of these additional steps Ra.

FIG. 5b comprises the same additional steps Ra, for the reading of the portions of lines of the matrix 10 that belong to the secondary windows. These steps Ra may be performed again after the reading steps with the reset of the complete lines of the matrix 10.

Of course, the invention may be reproduced by altering secondary aspects with respect to the modes of implementation that have been described in detail above, while maintaining at least some of advantages that have been quoted. Specifically, it should be reminded that the selection criteria for the secondary windows, as well as the number of these windows, can be adapted to each observation mission for which the invention is applied.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A method for using an image sensor onboard a satellite or an aircraft, whereby the image sensor comprises a matrix of photodetectors arranged along lines and columns of said matrix, and further comprises a plurality of line decoders and a plurality of column decoders, an addressing circuit and a sequencer coupled to the matrix of photodetectors by the addressing circuit, so as to control an individual operation of each photodetector according to accumulation, reading and reset steps,
the method comprising capturing a first image capture sequence, performed using photodetectors of a first selection within the matrix, and repeated at a first frequency to capture a first series of images at said first frequency, with said first image capture sequence comprising an accumulation, a reading and a reset step for each photodetector of the first selection,
capturing a second image capture sequence performed with photodetectors of a second selection within the matrix, and repeated at a second frequency to capture a second series of images at said second frequency,
in which the second frequency is higher than the first frequency, and the first selection comprises more photodetectors than the second selection, with photodetectors common to the first and second selections,
the second image capture sequence not comprising any reset step for each photodetector that is common to the first and second selections, in such a way that an accumulation step for a photodetector common to said first and second selections going on just before a reading step performed for said common photodetector according to the second image capture sequence, is continued just after said reading step is performed according to said second image capture sequence,
a plurality of images of the second series being captured with the photodetectors of the second selection while just one image of the first series is captured with photodetectors of the first selection.

2. The method according to claim 1, wherein the second selection of photodetectors is comprised in the first selection of photodetectors.

3. The method according to claim 1, wherein the photodetectors of the second selection are adjacent within at least one window in the matrix.

4. The method according to claim 3, further comprising a detection of line-of-sight variations for an imaging system that comprises the image sensor, said detection being performed from a comparison between two pattern positions within images captured successively according to the second image capture sequence with photodetectors of the second selection.

5. The method according to claim 4, wherein said at least one window, used for the images captured according to the second image capture sequence, is selected within the photodetector matrix from an image captured beforehand according to the first image capture sequence.

6. The method according to claim 4, wherein the second selection of photodetectors comprises a plurality of windows initially fixed, then used to capture images according to the second image capture sequence for each of said windows, and wherein at least one of said windows is subsequently selected, and the images captured according to the second image capture sequence for said at least one selected window are used to detect the line-of-sight variations.

7. The method according to claim 5, wherein said at least one window selected is selected based on:
/i/ an image texture within the window;
/ii/ an absence of clouds within the window; and
/iii/ when several windows are selected, a distribution of said selected windows within the matrix of the photodetectors.

8. The method according to claim 4, wherein the line-of-sight variations that are detected are used to control a system for compensating for said line-of-sight variations.

9. The method according to claim 8, wherein the line-of-sight variations are compensated for by moving at least one optical component of the imaging system.

10. The method according to claim 4, wherein the line-of-sight variations that are detected are used to control an attitude control system of the satellite or of the aircraft.

11. An image sensor adapted to be arranged onboard a satellite or an aircraft, said image sensor comprising a matrix of photodetectors arranged along lines and columns of said matrix, and further comprising a plurality of line decoders and a plurality of column decoders, an addressing circuit and a sequencer coupled to the matrix of photodetectors by the addressing circuit, said sequencer being adapted to control an individual operation of each photodetector according to accumulation, reading and reset steps,
the sequencer being further adapted to control a first image capture sequence, performed from a first selection of photodetectors within the matrix, and repeated at a first frequency to capture a first series of images at said first frequency, said first image capture sequence comprising an accumulation step, a reading step and a reset step for each photodetector of the first selection,
and to control a second image capture sequence, performed from a second selection of photodetectors within the matrix, and repeated at a second frequency to capture a second series of images at said second frequency,
the second frequency being higher than the first frequency, and the first selection comprising more photodetectors than the second selection, with photodetectors common to the first and second selections,
the sequencer being further adapted so that the second image capture sequence does not comprise a reset step for each photodetector common to the first and second selections, so that an accumulation step for a photodetector common to said first and second selections going on just before a reading step performed for said common photodetector according to the second image capture sequence, is continued just after said reading step is performed according to said second image capture sequence,
so that the image sensor is adapted to capture a plurality of images of the second series with the photodetectors of the second selection while just one image of the first series is captured with photodetectors of the first selection.

12. The image sensor according to claim 11, in which the sequencer is further adapted so that the second selection of photodetectors is comprised in the first selection of photodetectors.

13. The image sensor according to claim 11, in which the sequencer is further adapted so that the photodetectors of the second selection are adjacent within at least one window in the matrix.

14. An image capturing device comprising:
an image sensor according to claim 11; and
a module of detection of line-of-sight variations for an imaging system comprising said device, adapted to compare pattern positions within images captured successively according to the second image capture sequence with the photodetectors of the second selection, and to detect said line-of-sight variations by using a result of the comparison.

15. The device according to claim 14, further comprising a module for selecting a window within the matrix of photodetectors, and adapted to execute a method according to claim 5.

16. The device according to claim 14, in which the module of detection of line-of-sight variations is adapted to transmit data representing the line-of-sight variations, to an attitude control system of a satellite or aircraft, or a system for compensating for a jittering of the imaging system.
